(19) United States
(12) Patent Application Publication
(10) Pub. No.: US 2025/0199707 A1
(43) Pub. Date: Jun. 19, 2025

(54) LOGICAL BLOCK FORMATION BASED ON BLOCK ERASE LOOPS

(71) Applicant: WESTERN DIGITAL TECHNOLOGIES, INC., San Jose, CA (US)

(72) Inventors: NIRANJANI RAJAGOPAL, Bangalore (IN); GOPU S, Bangalore (IN); RAMANATHAN MUTHIAH, Bangalore (IN); RISHABH MANERKAR, Bangalore (IN)

(73) Assignee: WESTERN DIGITAL TECHNOLOGIES, INC., San Jose, CA (US)

(21) Appl. No.: 18/541,892

(22) Filed: Dec. 15, 2023

(51) Int. Cl. G06F 3/06

(52) U.S. Cl. CPC G06F 3/0652; G06F 3/0604; G06F 3/0679

(57) ABSTRACT

A storage device forms a meta block based on block erase loops. During testing of a memory device coupled to the storage device, a controller separates the physical blocks on the memory device into categories based on a check and stores block data with category markings. During use of the storage device, the controller retrieves the block data from a non-volatile memory, determines different categories from the block data, and identifies an erasure marking for a physical block. The controller forms a meta block to include the physical blocks from at least two dies. The physical blocks in the meta block have the same erasure marking. The controller also dynamically recategorizes and relinks the physical block to another meta block when a weight associated with the physical block exceeds an erase loop threshold.

### BACKGROUND

A storage device may be communicatively coupled to a host and to non-volatile memory including, for example, a NAND flash memory device on which the storage device may store data received from the host. The memory device may include one or more dies on which data may be stored. Each die may be further divided into blocks, wherein blocks are the smallest units that can be erased from the NAND flash memory. There may be different quality of memory devices and the memory devices may be classified according to one or more quality thresholds. For example, memory devices having quality parameters that exceed a first quality threshold may be classified as first quality memory devices and may be placed in one set of products and memory devices having quality parameters that exceed a second quality threshold but not the first quality threshold may be classified as second quality memory devices and may be placed in a second set of products.

The second quality memory devices may be constrained in that the blocks in these devices may be double erased. Double erasing is an operation where an erase is performed back-to-back on a block to correct for certain failures on the memory device and improve the erase quality of the block. In general, the double erase operation is time consuming, and a block's performance may be impacted by the extra erase time. The double erase operation may also cause higher data retention losses on the blocks on which the double erase operation is performed. Memory devices including physical blocks needing to be double erased may also have higher latency. As such, a double erase operation may impact performance centric physical blocks that may be used for host data.

During use of the storage device, a meta block may be formed in an interleaved manner, wherein the meta block is a logical block that may include a physical block from two or more dies on the memory device. When a meta block includes a performance centric physical block, an issue on the other physical blocks in the meta block may impact the performance centric physical block. As such, when a double erase is performed on a meta block including one or more performance centric physical blocks, the double erase time required to erase the contents of the meta block may impact the performance centric physical blocks in the meta block.

### SUMMARY

In some implementations, the storage device may form a meta block based on block erase loops. The storage device includes a memory device including at least two dies including physical blocks for storing data. A controller on the storage device may retrieve block data from a non-volatile memory, determine different categories of physical blocks on the memory device from the block data, and identify an erasure marking for a physical block. The controller may form a meta block to include the physical blocks from at least two dies. The physical blocks in the meta block have the same erasure marking. The controller may dynamically recategorizes and relinks the physical block to another meta block when a weight associated with the physical block exceeds an erase loop threshold.

In some implementations, a method is provided for forming a meta block in a storage device based on block erase loops. The method includes retrieving block data for physical blocks on a memory device from a non-volatile memory and determining different categories of physical blocks on the memory device from the block data. The method also includes identifying an erasure marking for a physical block from the block data and forming a meta block to include the physical blocks from the at least two dies, wherein the physical blocks in the meta block have the same erasure marking. The method further includes dynamically recategorizing and relinking the physical block to another meta block when a weight associated with the physical block exceeds an erase loop threshold.

In some implementations, a method is provided for forming a meta block in a storage device based on block erase loops. The method includes during testing of a memory device, performing a data mis-compare check on a physical block after completing a successful erase verify operation on the physical block, separating physical blocks on the memory device into categories based on the data mis-compare check, and storing block data for the physical blocks with category markings in a non-volatile memory. The method also includes during use of the memory device, retrieving block data for physical blocks from the non-volatile memory, determining different categories of physical blocks on the memory device from the block data, and identifying an erasure marking for a physical block from the block data. The method also includes forming a meta block to include the physical blocks from the at least two dies, wherein the physical blocks in the meta block have a same erasure marking, and dynamically recategorizing and relinking the physical block to another meta block when a weight associated with the physical block exceeds an erase loop threshold.

### BRIEF DESCRIPTION OF THE SEVERAL VIEWS OF THE DRAWINGS

FIG. 1 is a schematic block diagram of an example storage device in accordance with some implementations.

FIG. 2 is a block diagram of blocks in a memory device in accordance with some implementations.

FIG. 3 is a block diagram of a block listing in a user read-only memory in accordance with some embodiments.

FIG. 4 is a block diagram of example meta blocks formed from the blocks shown in FIG. 2 in accordance with some embodiments.

FIG. 5 is a flow diagram of an example process for categorizing physical blocks on a storage device based on erase loops in accordance with some implementations.

FIG. 6 is a flow diagram of an example process for forming meta blocks on a storage device based on erase loops in accordance with some implementations.

FIG. 7 is a diagram of an example environment in which systems and/or methods described herein are implemented.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of implementations of the present disclosure.

The apparatus and method components have been represented where appropriate by conventional symbols in the drawings, showing those specific details that are pertinent to understanding the implementations of the present disclosure so as not to obscure the disclosure with details that will be readily apparent to those of ordinary skill in the art.

### DETAILED DESCRIPTION OF THE INVENTION

The following detailed description of example implementations refers to the accompanying drawings The same reference numbers in different drawings may identify the same or similar elements.

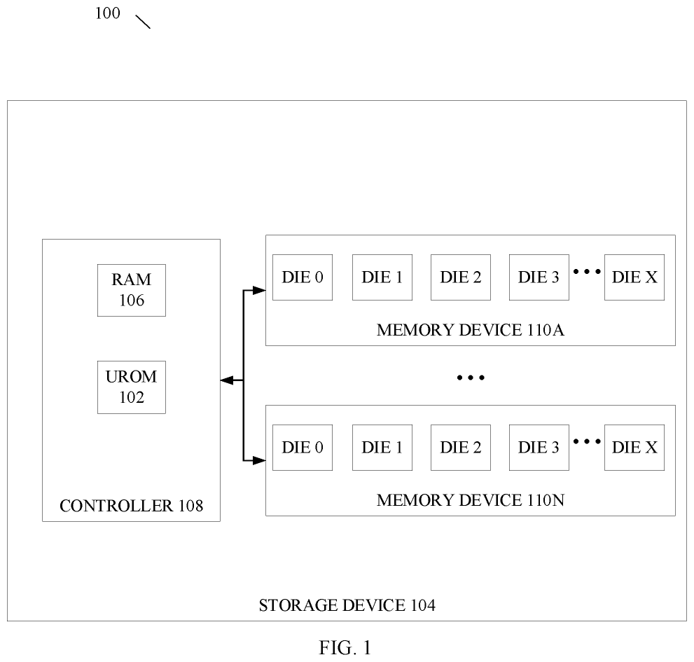

FIG. 1 is a schematic block diagram of an example storage device in accordance with some implementations. Storage device 104 may include a user read only memory (U-ROM) 102, a random-access memory (RAM) 106, a controller 108, and one or more non-volatile memory devices 110a-110n (referred to herein as the memory device(s) 110). Storage device 104 may be, for example, a solid-state drive (SSD), and the like. UROM 102 may be a register or other non-volatile memory in storage device 104. RAM 106 may be temporary storage such as a dynamic RAM (DRAM) that may be used to cache information in storage device 104.

Controller 108 may interface with a host and process foreground operations including instructions transmitted from the host. For example, controller 108 may read data from and/or write to memory device 110 based on instructions received from the host. Controller 108 may also execute background operations to manage resources on memory device 110. For example, controller 108 may monitor memory device 110 and may execute garbage collection and other relocation functions per internal relocation algorithms to refresh and/or relocate the data on memory device 110.

Memory device 110 may be flash based. For example, memory device 110 may be a NAND flash memory that may be used for storing host and control data over the operational life of memory device 110. Memory device 110 may include multiple dies (shown as Die 0-Die X). Die 0-Die X may be divided into blocks. A meta block (i.e., a logical block) may be formed in an interleaved manner where the meta block may include a physical block from two or more dies. Memory device 110 may be included in storage device 104 or may be otherwise communicatively coupled to storage device 104.

Data may be stored in the blocks on memory device 110 in various formats, with the formats being defined by the number of bits that may be stored per memory cell. For example, a single-layer cell (SLC) format may write one bit of information per memory cell, a multi-layer cell (MLC) format may write two bits of information per memory cell, a triple-layer cell (TLC) format may write three bits of information per memory cell, and a quadruple-layer cell (QLC) format may write four bits of information per memory cell, and so on. Formats storing fewer bits in each cell are more easily accessed, durable, and less error-prone than formats storing more bits per cell. However, formats storing fewer bits in each cell are also more expensive.

To increase the performance of storage device 104, the blocks on memory device 110 may be divided into two pools, a main area pool and a burst pool. For example, if storage device 104 has one terabyte (TB) capacity, the main area pool may include, for example, one thousand TLC blocks, each of which may store one gigabyte of data, covering the 1TB capacity of storage device 104. The burst pool may include additional blocks equal to a percentage of the blocks in the main pool. The blocks in the burst pool may be SLC blocks, some of which may be used for storing host data and some of which may be used for storing control data.

The SLC blocks used for storing control data in the burst pool may be assigned to a control pool and may be used by storage device 104 for storing management information that is internal to the operations on storage device 104. For example, the SLC control blocks may store management information that may be used internally on storage device 104 for background operations. Storing information on blocks, such as TLC blocks, which store more bits of information per memory cell may be a more complex operation than storing information on blocks, such as SLC blocks, which store fewer bits per memory cell. As such, the TLC blocks in the main area pool may be used for sustained write performance. The SLC blocks in the burst pool used for storing host data may be reserved for performance-related tasks (for example, peak/burst write performance-related tasks).

During operations when the host sends data to storage device 104 or requests data from storage device 104, the host may expect a certain quality of service (QOS) from storage device 104, such that background and other operations on storage device 104 may minimally impact host commands. To ensure that double erase operations on blocks on memory device 110 do not affect the performance of storage device 104, when memory device 110 is tested, blocks on Die 0-Die X on memory device 110 may be categorized. After an erase operation on a block on memory device 110, even though an erase verify operation on the block may be successful, the block may go through a data mis-compare (DMC) check. The DMC may be used to count the number of bits above a read level. The blocks on memory device 110 may be segregated in at least two categories based on a DMC threshold. When the number of bits above a read level for a block is greater than or equal to the DMC threshold, the block may be given a first weight. When the number of bits above a read level for a block is less than the DMC threshold, the block may be given a second weight.

Controller 108 may mark blocks assigned the first weight as requiring more than one erase loop and may place those blocks in the first category. Controller 108 may mark blocks assigned the second weight as requiring one erase loop and may be placed in a second category. A list of the blocks with the corresponding markings may be stored in U-ROM 102.

Controller 108 may use the physical blocks in the second category (i.e., physical blocks using one erase cycle) during burst performances, as control blocks, or during high performance host workload requirements. Controller 108 may use the physical blocks in the first category (i.e., physical blocks using more than one erase cycles) during low host workload, block idle time, and for other purposes, such as read scrub and wear levelling, when the erase latency may not be a bottleneck parameter for a given workload.

During use, before forming meta blocks, controller 108 may fetch block data from the U-ROM 102 and decode the block data to identify the different categories of physical blocks on memory device 110 and the erasure marking of a physical block (i.e., whether a physical block requires one or more erase loops). When a meta block is being erased, the erasure occurs on each of the physical blocks that makes up the meta block. To ensure that a physical block requiring a double erase does not adversely affect another physical block in a meta block requiring a single erase loop, controller 108 may form meta blocks that include physical blocks that may have the same erasure marking. Based on the different categories of physical blocks on memory device 110, during logical blocks formation, controller 108 may create meta blocks, wherein each meta block may include a physical block from two or more dies and the physical blocks in each meta block may belong to the same category (i.e., the physical blocks in each meta block may require the same number of erase loops). For example, controller 108 may pair physical blocks across the dies needing one erase cycle into a first meta block and pair physical blocks across the dies needing two erase cycles into a second meta block. This will ensure that meta blocks do not include physical blocks requiring different erase cycles such that the erase time on a physical block requiring two erase loops may not adversely affect another physical block requiring one erase loop.

Those meta blocks including physical blocks needing two erase cycles may be selected for host operations that are not impacted by performance. Those meta blocks including physical blocks needing one erase cycle may be selected for host operations that may be impacted by the performance of storage device 104. As such, meta blocks with an increased number of erase loops (two or more erase cycle) may be used during low host workloads, during idle times, and for background operations such as read scrub and wear levelling where the erase latency may not be a bottleneck parameter for a given workload.

If controller 108 determines that the host workload is not at its peak based, for example, on the sum of data rates as seen by controller 108, controller 108 may determine if using physical blocks requiring multiple erase loops may cause a bottleneck for a given host workload. If controller 108 determines that using physical blocks requiring multiple erase loops may not cause a bottleneck for the host data, controller 108 may use meta blocks having physical blocks in a category associated with multiple erase loops. Controller 108 may dynamically choose a meta block for host data, wherein in choosing the meta block, controller 108 may determine the historical host data rate to select a meta block based on the associated erase loops.

When controller 108 performs a block erase, controller 108 may determine that the erasure of some physical blocks on memory device 110 may be incomplete or may need another erase operation. If controller 108 determines that a physical block in the category associated with one erase loop may need another erase operation, controller 108 may dynamically determine that physical block should be placed in the category associated with more than one erase loop (i.e., in another category associated with a different number of erase loops). For instance, if due to wear and tear a physical block in the category associated with one erase loop now needs another erase operation, controller 108 may determine that the information in U-ROM 102 is no longer valid for that physical block. In some implementations, controller 108 may execute a weight-based mechanism, wherein controller 108 may dynamically increase a wear weight assigned to a block when a parameter, for example, a program erase count, associated with a physical block increases. When the weight assigned to the parameter exceeds an erase loop threshold, controller 108 may recategorize the physical block and assign the physical block to the category associated with more than one erase loop. For example, when the program erase count for a physical block exceeds the erase loop threshold, controller 108 may recategorize the physical block and assign the physical block to the category associated with more than one erase loop. When the nature (for example, the weight) of a physical block changes during run time and the physical block is recategorized from one erase loop to more erase loops, the physical block may be paired according to its new category and relinked to a meta block having physical blocks in its new category. The physical blocks may thus be chosen from correct groups based on application requirements.

After controller 108 segregates a physical block based on the weight assigned erase loops, and when controller 108 confirms that the erase nature of a physical block has changed, controller 108 may convert a physical block from a format storing more bits per cell to a format storing fewer bits per cell. For example, controller 108 may convert a TLC block to a SLC or hybrid block to bring down the number of erase loops, as reduced erase loops may be sufficient for lower configurations storing fewer bits per memory cell. Based on the erase loop requirement of a physical block, controller 108 may maintain a physical block as a capacity block, a burst block, or spare block. This way, controller 108 may swap certain blocks from different pools such as control pool, capacity pool, over provisioned pool, or spare pool, based on the erase loops when controller 108 converts the block type from a higher cell state (for example, TLC) to a lower cell state (for example, SLC).

Storage device 104 may perform these processes based on a processor, for example, controller 108 executing software instructions stored by a non-transitory computer-readable medium, such as storage component 110. As used herein, the term “computer-readable medium” refers to a non-transitory memory device. Software instructions may be read into storage component 110 from another computer-readable medium or from another device. When executed, software instructions stored in storage component 110 may cause controller 108 to perform one or more processes described herein. Additionally, or alternatively, hardware circuitry may be used in place of or in combination with software instructions to perform one or more processes described herein. Thus, implementations described herein are not limited to any specific combination of hardware circuitry and software. System 100 may include additional components (not shown in this figure for the sake of simplicity). FIG. 1 is provided as an example. Other examples may differ from what is described in FIG. 1.

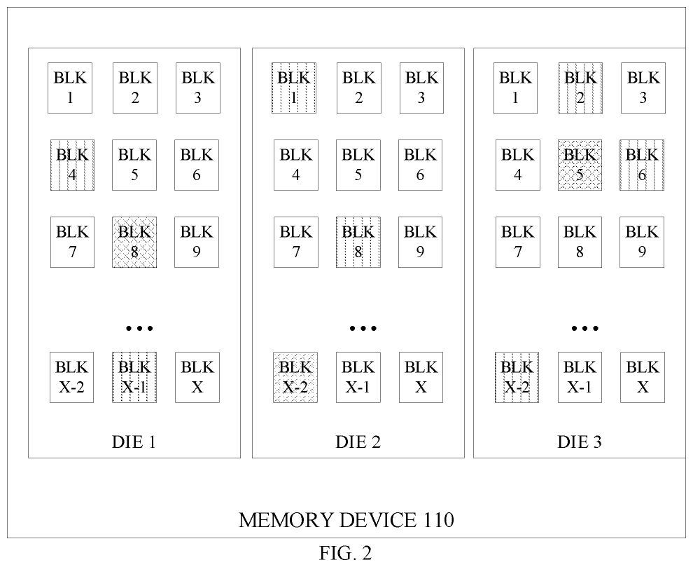

FIG. 2 is a block diagram of blocks in a memory device in accordance with some implementations. Memory device 110 includes 3 dies, each of which includes X blocks (shown as BLK 1-BLK X). When memory device 110 is being tested, an erase operation may be carried out on each block. Blocks failing the erase or erase verify operation may be marked as bad blocks and may appear as factory marked bad blocks to controller 108 so that controller 108 may skip these blocks during foreground and background operations. For example, BLK 8 in DIE 1, BLK X-2 in DIE 2 and BLK 5 in DIE 3 may be marked as factory bad blocks for failing the erase or erase verify operation. The remaining blocks may go through a DMC check. The blocks on memory device 110 may be segregated in at least two categories based on a DMC threshold, wherein the number of bits above a read level for a block may be greater than or equal to the DMC threshold for BLK 4 and BLK X-1 in DIE 1, BLK 1 and BLK 8 in DIE 2 and BLK 2, BLK 6 and BLK X-2 in DIE 3 and controller 108 may mark these blocks as belonging to a first category requiring more than one erase loop. Controller 108 may mark the remaining blocks in DIE 1-DIE 3 as belonging to a second category requiring one erase loop. As indicated above FIG. 2 is provided as an example. Other examples may differ from what is described in FIG. 2.

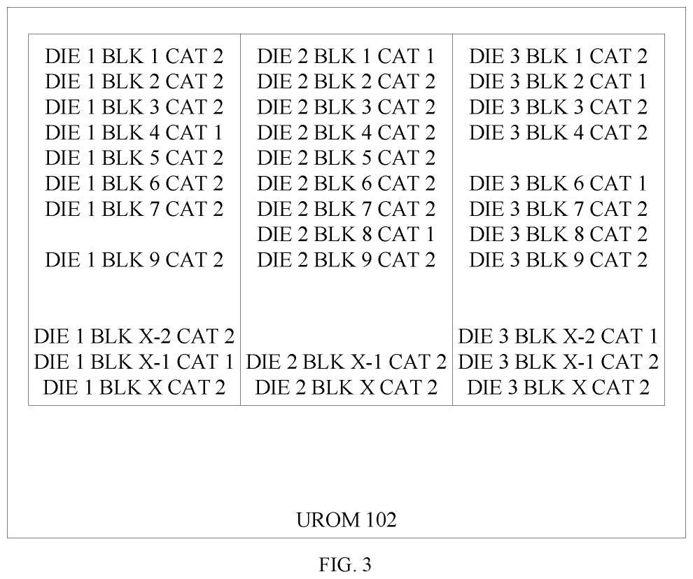

FIG. 3 is a block diagram of a block listing in a user read-only memory in accordance with some embodiments. The block listing may correspond to the example memory device 110 shown in FIG. 2. The blocks marked as factory bad blocks (i.e., BLK 8 in DIE 1, BLK X-2 in DIE 2 and BLK 5 in DIE 3) may not be listed in UROM 102. As indicated above FIG. 3 is provided as an example. Other examples may differ from what is described in FIG. 3.

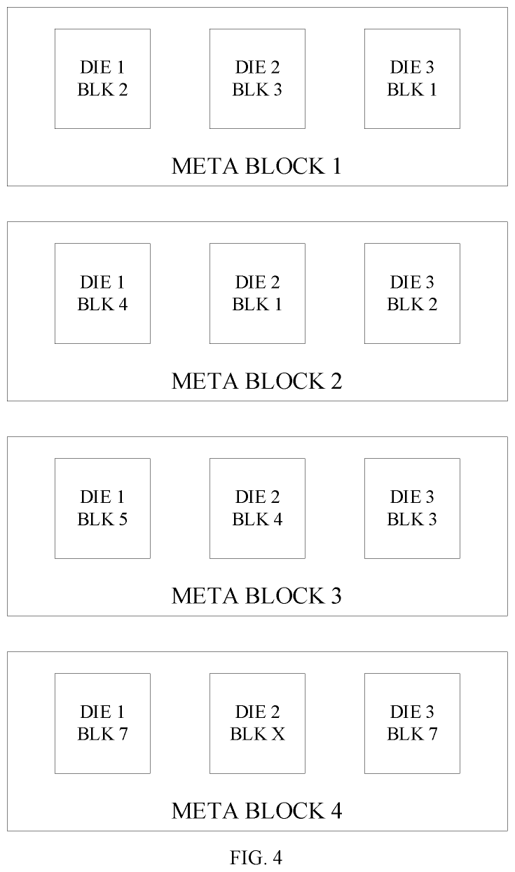

FIG. 4 is a block diagram of example meta blocks formed from the blocks shown in FIG. 2 in accordance with some embodiments. Meta blocks 1, 3, and 4 may include physical blocks belonging to category 2 and meta block 2 may include physical blocks belonging to category 1. Controller 108 may use meta blocks 1, 3, and 4 during burst performances, as control blocks, or during high performance host workload requirements. Controller 108 may use meta block 2 during low host workload, block idle time, and for other purposes, such as read scrub and wear levelling, when the erase latency may not be a bottleneck parameter for a given workload. As indicated above FIG. 4 is provided as an example. Other examples may differ from what is described in FIG. 4.

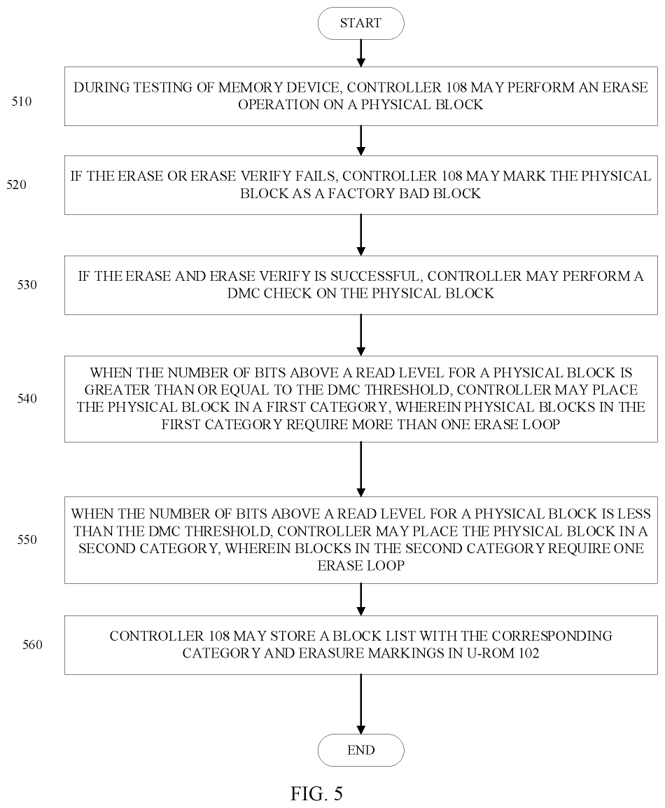

FIG. 5 is a flow diagram of an example process for categorizing physical blocks on a storage device based on erase loops in accordance with some implementations. At 510, during testing of memory device, controller 108 may perform an erase operation on a physical block. At 520, if the erase or erase verify fails, controller 108 may mark the physical block as a factory bad block. At 530, if the erase and erase verify is successful, controller may perform a DMC check on the physical block. At 540, when the number of bits above a read level for a physical block is greater than or equal to the DMC threshold, controller may place the physical block in a first category, wherein physical blocks in the first category require more than one erase loop. At 550, when the number of bits above a read level for a physical block is less than the DMC threshold, controller may place the physical block in a second category, wherein blocks in the second category require one erase loop. At 560, controller 108 may store a block list with the corresponding category and erasure markings in U-ROM 102. As indicated above FIG. 5 is provided as an example. Other examples may differ from what is described in FIG. 5.

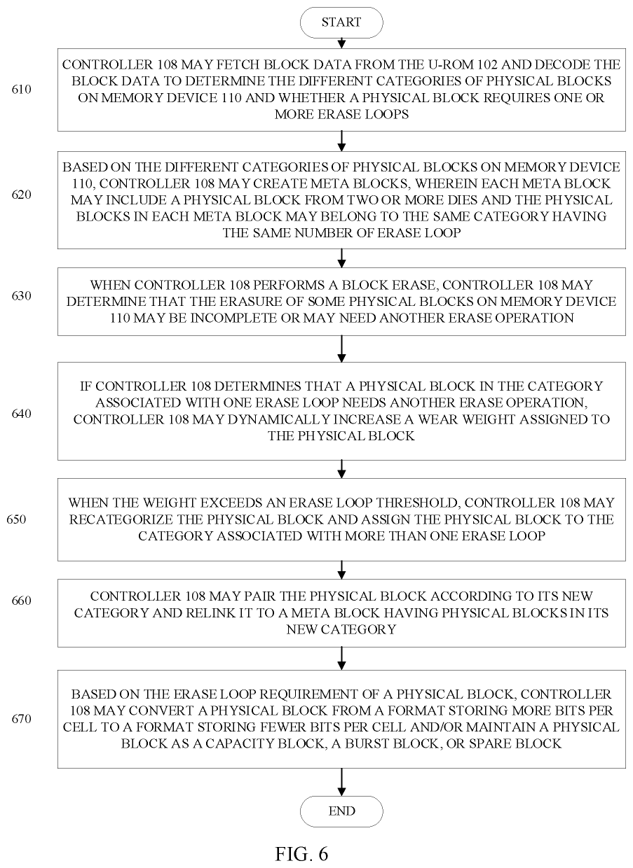

FIG. 6 is a flow diagram of an example process for forming meta blocks on a storage device based on erase loops in accordance with some implementations. At 610, controller 108 may fetch block data from the U-ROM 102 and decode the block data to determine the different categories of physical blocks on memory device 110 and whether a physical block requires one or more erase loops. At 620, based on the different categories of physical blocks on memory device 110, controller 108 may create meta blocks, wherein each meta block may include a physical block from two or more dies and the physical blocks in each meta block may belong to the same category having the same number of erase loops.

At 630, when controller 108 performs a block erase, controller 108 may determine that the erasure of some physical blocks on memory device 110 may be incomplete or may need another erase operation. At 640, if controller 108 determines that a physical block in the category associated with one erase loop needs another erase operation, controller 108 may dynamically increase a wear weight assigned to the physical block. For example, the wear weight may be associated with the erase loop count of that block and controller 108 may dynamically increase a wear weight assigned to the physical block when the program erase count associated with the physical block is increased. At 650, when the weight exceeds an erase loop threshold, controller 108 may recategorize the physical block and assign the physical block to the category associated with more than one erase loop.

At 660, controller 108 may pair the physical block according to its new category and relink it to a meta block having physical blocks in its new category. At 670, based on the erase loop requirement of a physical block, controller 108 may convert a physical block from a format storing more bits per cell to a format storing fewer bits per cell and/or maintain a physical block as a capacity block, a burst block, or spare block. As indicated above FIG. 6 is provided as an example. Other examples may differ from what is described in FIG. 6.

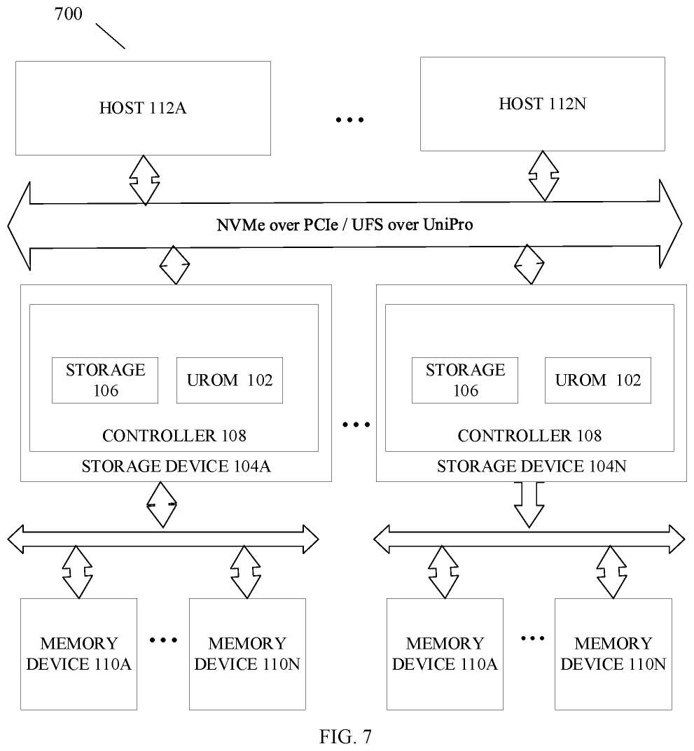

FIG. 7 is a diagram of an example environment in which systems and/or methods described herein are implemented. As shown in FIG. 7, Environment 700 may include hosts 102-102n (referred to herein as host(s) 102), and storage devices 104a-104n (referred to herein as storage device(s) 104).

Storage device 104 may include a controller 108 to manage the resources on storage device 104. Controller 108 may form meta blocks base on the number of erase loops being performed on a physical block, wherein a meta block may including physical blocks having the same number of erase loops. Hosts 102 and storage devices 104 may communicate via Non-Volatile Memory Express (NVMe) over peripheral component interconnect express (PCI Express or PCIe) standard, the Universal Flash Storage (UFS) over Unipro, or the like.

Devices of Environment 700 may interconnect via wired connections, wireless connections, or a combination of wired and wireless connections. For example, the network of FIG. 7 may include a cellular network (e.g., a long-term evolution (LTE) network, a code division multiple access (CDMA) network, a 3G network, a 4G network, a 5G network, another type of next-generation network, and/or the like), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, a cloud computing network, or the like, and/or a combination of these or other types of networks.

The number and arrangement of devices and networks shown in FIG. 7 are provided as an example. In practice, there may be additional devices and/or networks, fewer devices and/or networks, different devices and/or networks, or differently arranged devices and/or networks than those shown in FIG. 7. Furthermore, two or more devices shown in FIG. 7 may be implemented within a single device, or a single device shown in FIG. 7 may be implemented as multiple, distributed devices. Additionally, or alternatively, a set of devices (e.g., one or more devices) of Environment 700 may perform one or more functions described as being performed by another set of devices of Environment 700.

The foregoing disclosure provides illustrative and descriptive implementations but is not intended to be exhaustive or to limit the implementations to the precise form disclosed herein. One of ordinary skill in the art will appreciate that various modifications and changes can be made without departing from the scope of the present disclosure as set forth in the claims below. Accordingly, the specification and figures are to be regarded in an illustrative rather than a restrictive sense, and all such modifications are intended to be included within the scope of present teachings.

As used herein, the term “component” is intended to be broadly construed as hardware, firmware, and/or a combination of hardware and software. It will be apparent that systems and/or methods described herein may be implemented in different forms of hardware, firmware, and/or a combination of hardware and software.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set.

No element, act, or instruction used herein should be construed as critical or essential unless explicitly described as such. Also, as used herein, the articles “a” and “an” are intended to include one or more items and may be used interchangeably with “one or more.” Furthermore, as used herein, the term “set” is intended to include one or more items (e.g., related items, unrelated items, a combination of related items, unrelated items, and/or the like), and may be used interchangeably with “one or more” The term “only one” or similar language is used where only one item is intended. Further, the phrase “based on” is intended to mean “based, at least in part, on” unless explicitly stated otherwise.

Moreover, in this document, relational terms such as first and second, top and bottom, and the like, may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, or “contains . . . a” does not, without more constraints, preclude the existence of additional identical elements in the process, method, article, or apparatus that comprises, has, includes, contains the element. The terms “substantially”, “essentially”, “approximately”, “about” or any other version thereof, are defined as being close to as understood by one of ordinary skill in the art, and in one non-limiting implementation, the term is defined to be within 10%, in another implementation within 5%, in another implementation within 1% and in another implementation within 0.5%. The term “coupled” as used herein is defined as connected, although not necessarily directly and not necessarily mechanically. A device or structure that is “configured” in a certain way is configured in at least that way but may also be configured in ways that are not listed.

We claim:

1. A storage device forms a meta block based on block erase loops, the storage device comprises:
a memory device including at least two dies including physical blocks for storing data;
a controller to retrieve block data from a non-volatile memory, determine different categories of physical blocks on the memory device from the block data, identify an erasure marking for a physical block, form a meta block to include the physical blocks from the at least two dies, wherein the physical blocks in the meta block have a same erasure marking, and dynamically recategorizes and relinks the physical block to another meta block when a weight associated with the physical block exceeds an erase loop threshold.

2. The storage device of claim 1, wherein during testing of the memory device, the controller performs a data mis-compare check on the physical block after completing a successful erase verify operation on the physical block, separates the physical blocks on the memory device into categories based on the data mis-compare check and stores a listing of the physical blocks with category markings in the non-volatile memory.

3. The storage device of claim 2, wherein the controller places physical blocks requiring more than one erase loop in a first category and physical blocks requiring one erase loop are placed in a second category.

4. The storage device of claim 1, wherein a first meta block includes physical blocks from the at least two dies with one erase cycle and a second meta block includes physical blocks from the at least two dies with two erase cycles.

5. The storage device of claim 1, wherein when the controller determines that a host workload is not at its peak and that using physical blocks requiring multiple erase loops do not cause a bottleneck for a given host workload, the controller uses the meta block having physical blocks in a category associated with multiple erase loops.

6. The storage device of claim 1, wherein the controller dynamically chooses the meta block for host data, wherein in choosing the meta block, the controller determines a historical host data rate to select the meta block based on associated erase loops.

7. The storage device of claim 1, wherein in dynamically recategorizing the physical block, the controller dynamically determines that the physical block should be placed in another category associated with a different number of erase loops when a parameter associated with a physical block increases, and increases the weight assigned to the physical block.

8. The storage device of claim 1, wherein when the weight associated with the physical block exceeds the erase loop threshold, the controller converts the physical block from a format storing more bits per cell to a format storing fewer bits per cell.

9. A method for forming a meta block in a storage device based on block erase loops, the storage device comprises a controller to execute the method comprising:
retrieving block data for physical blocks on a memory device from a non-volatile memory;
determining different categories of physical blocks on the memory device from the block data;
identifying an erasure marking for a physical block from the block data;
forming a meta block to include the physical blocks from the at least two dies, wherein the physical blocks in the meta block have a same erasure marking, and
dynamically recategorizing and relinking the physical block to another meta block when a weight associated with the physical block exceeds an erase loop threshold.

10. The method of claim 9, further comprising, during testing of the memory device, performing a data mis-compare check on the physical block after completing a successful erase verify operation on the physical block, separating the physical blocks on the memory device into categories based on the data mis-compare check, and storing a listing of the physical blocks with category markings in the non-volatile memory.

11. The method of claim 10, further comprising placing physical blocks requiring more than one erase loop in a first category and physical blocks requiring one erase loop in a second category.

12. The method of claim 9, wherein forming comprises forming a first meta block to include physical blocks from the at least two dies with one erase cycle and forming a second meta block to include physical blocks from the at least two dies with two erase cycles.

13. The method of claim 9, further comprising determining that a host workload is not at its peak and that using physical blocks requiring multiple erase loops do not cause a bottleneck for a given host workload, the method further comprising using the meta block having physical blocks in a category associated with multiple erase loops.

14. The method of claim 9, further comprising dynamically choosing the meta block for host data, wherein in choosing the meta block, the method comprises determining a historical host data rate to select the meta block based on associated erase loops.

15. The method of claim 9, wherein in dynamically recategorizing the physical block, the method comprises dynamically determining that the physical block should be placed in another category associated with a different number of erase loops when a parameter associated with a physical block increases, and increasing the weight assigned to the physical block.

16. The method of claim 9, wherein when the weight associated with the physical block exceeds the erase loop threshold, the method comprises converting the physical block from a format storing more bits per cell to a format storing fewer bits per cell.

17. A method for forming a meta block in a storage device based on block erase loops, the storage device comprises a controller to execute the method comprising:
during testing of a memory device, performing a data mis-compare check on a physical block after completing a successful erase verify operation on the physical block, separating physical blocks on the memory device into categories based on the data mis-compare check, and storing block data for the physical blocks with category markings in a non-volatile memory;
during use of the memory device,
retrieving block data for physical blocks from the non-volatile memory;
determining different categories of physical blocks on the memory device from the block data;
identifying an erasure marking for a physical block from the block data;
forming a meta block to include the physical blocks from the at least two dies, wherein the physical blocks in the meta block have a same erasure marking, and
dynamically recategorizing and relinking the physical block to another meta block when a weight associated with the physical block exceeds an erase loop threshold.

18. The method of claim 17, further comprising placing physical blocks requiring more than one erase loop in a first category and physical blocks requiring one erase loop in a second category.

19. The method of claim 17, wherein forming comprises forming a first meta block to include physical blocks from the at least two dies with one erase cycle and forming a second meta block to include physical blocks from the at least two dies with two erase cycles.

20. The method of claim 17, wherein when the weight associated with the physical block exceeds the erase loop threshold, the method comprises converting the physical block from a format storing more bits per cell to a format storing fewer bits per cell.
